(19) United States
(12) Patent Application Publication
(10) Pub. No.: US 2021/0131375 A1
(43) Pub. Date: May 6, 2021

(54) COMBUSTION CHAMBER STRUCTURE OF ENGINE

(71) Applicant: Mazda Motor Corporation, Aki-gun (JP)

(72) Inventors: Ryo Kiyosue, Aki-gun (JP); Hiroyasu Uchida, Aki-gun (JP); Akira Kageyama, Aki-gun (JP); Tsugio Fukube, Aki-gun (JP); Yoshiyuki Koga, Aki-gun (JP); Masatoshi Seto, Aki-gun (JP); Yudai Koshiro, Aki-gun (JP); Junki Hori, Aki-gun (JP)

(21) Appl. No.: 17/070,052

(22) Filed: Oct. 14, 2020

(30) Foreign Application Priority Data
Oct. 31, 2019 (JP) 2019-198402

(51) Int. Cl. F02F 1/18; F02M 25/022; F02F 3/28; F02F 7/00; B05D 7/14

(52) U.S. Cl. CPC F02F 1/18; F02M 25/022; B05D 7/14; F02F 7/0021; F02F 3/28

(57) ABSTRACT

A structure of a combustion chamber applied to an engine provided with a piston that reciprocates inside a cylinder, and a fuel supply system that supplies fuel to the combustion chamber defined by the cylinder and the piston, mixture gas of fuel from the fuel supply system and air combusting inside the combustion chamber, is provided. The structure includes a first heat insulating layer covering at least a part of a combustion chamber wall surface defining the combustion chamber and made of a material with a lower thermal conductivity than the combustion chamber wall surface, and a second heat insulating layer covering the first heat insulating layer and facing toward the combustion chamber, a thermal diffusivity of the second heat insulating layer being larger than the thermal diffusivity of the first heat insulating layer. The second heat insulating layer has a thickness less than the first heat insulating layer.

### TECHNICAL FIELD

The present disclosure relates to a structure of a combustion chamber which is applied to engines in which a mixture gas of fuel and air combusts inside the combustion chamber.

### BACKGROUND OF THE DISCLOSURE

In order to improve the thermal efficiency of an engine, it is proposed to cover a wall surface of a combustion chamber by a heat barrier layer. For example, JP2018-021225A discloses a combustion chamber structure of an engine in which a middle layer comprised of a thermal-spraying film with a linear expansion coefficient larger than a base material which constitutes the combustion chamber is formed on the surface of the base material, and a heat barrier layer comprised of a thermal-spraying film with a linear expansion coefficient larger than the middle layer is formed on the surface of the middle layer.

According to the combustion chamber structure disclosed in JP2018-021225A, since a difference between the linear expansion coefficients of the base material and the heat barrier layer is eased, the resistance to thermal stress improves. Moreover, since the combustion chamber wall surface is dually covered with the heat barrier layer and the middle layer, the heat energy released outside (cooling loss) from the combustion chamber wall surface can be further reduced.

As described above, in JP2018-021225A, both the heat barrier layer and middle layer are formed by thermal-spraying film, and the material(s) of the heat barrier layer and the middle layer is selected based on the linear expansion coefficient to solve the problem of the resistance to thermal stress which is a concern in this situation. In other words, in JP2018-021225A, although the combustion chamber wall surface is covered with the two layers comprised of the heat barrier layer and the middle layer, there is no thought of optimizing this combination of two layers in terms of reducing the cooling loss. Therefore, it may not fully improve the thermal efficiency of the engine. That is, JP2018-021225A does not fully utilize the merit by dually covering the combustion chamber wall surface for the reduction of the cooling loss.

### SUMMARY OF THE DISCLOSURE

The present disclosure is made in view of the above situations, and one purpose thereof is to provide a structure of a combustion chamber of an engine, which can fully reduce cooling loss.

According to one aspect of the present disclosure, a structure of a combustion chamber is provided, which is applied to an engine provided with a piston configured to reciprocate inside a cylinder to define the combustion chamber and a fuel supply system configured to supply fuel to the combustion chamber where a mixture gas of the fuel and air combusts. The structure includes a first heat insulating layer covering at least a part of a combustion chamber wall surface defining the combustion chamber and made of a material with a lower thermal conductivity than the combustion chamber wall surface, and a second heat insulating layer covering the first heat insulating layer and facing toward the combustion chamber. A thermal diffusivity of the second heat insulating layer is larger than the thermal diffusivity of the first heat insulating layer. The second heat insulating layer has a thickness less than the first heat insulating layer.

According to this configuration, since the combustion chamber wall surface is dually covered with the first heat insulating layer and the second heat insulating layer, it can be reduced that the combustion heat generated in the combustion chamber is emitted outside via the combustion chamber wall surface, and therefore, cooling loss can be reduced. Particularly, since the thermal diffusivity of the second heat insulating layer which faces the combustion chamber (it directly contacts combustion gas) is relatively large, the temperature of the second heat insulating layer can be raised when the temperature inside the combustion chamber elevates according to the combustion of the mixture gas so that the temperature rise quickly follows the temperature rise inside the combustion chamber. Therefore, a temperature difference between the second heat insulating layer and the combustion chamber can be made as small as possible, and thereby, the cooling loss which originates in this temperature difference can fully be reduced. Moreover, since the thickness of the first heat insulating layer located between the second heat insulating layer and the combustion chamber wall surface is relatively large, the heat transfer from the second heat insulating layer to the combustion chamber wall surface can fully be reduced by the first heat insulating layer, and therefore, the cooling loss can also be reduced. As described above, according to this configuration, since the cooling loss is fully reduced by the combination of the first heat insulating layer and the second heat insulating layer, the thermal efficiency of the engine can be effectively improved.

The engine may be provided with a steam injection valve configured to inject steam toward a crown surface of the piston. The first heat insulating layer and the second heat insulating layer may be provided to the crown surface of the piston.

When the steam injection valve which injects steam toward the piston crown surface is provided as described above, the injected steam can be used as an operating gas, and therefore, an output torque of the engine can be increased. That is, the steam injected into the combustion chamber from the steam injection valve expands inside the combustion chamber, and therefore, it functions as the operating gas which depresses the piston. Therefore, the work (energy) which depresses the piston increases to increase the output torque. In addition, since steam rather than liquid water is injected, the amount by which the work is increased can be prevented from being deducted by energy consumption due to latent heat of vaporization of water, and the output torque can be effectively increased.

Moreover, since the first heat insulating layer and the second heat insulating layer are provided to the piston crown surface toward which steam is injected, the steam that condenses (dropwise condensation) at the piston crown surface can be reduced and the increasing effect of the torque is deducted. Particularly, since the first heat insulating layer with the relatively small thermal diffusivity and large thickness is disposed between the second heat insulating layer and the piston crown surface, the temperature of the second heat insulating layer which directly contacts the gas inside the combustion chamber including the steam can be raised averagely by using the first heat insulating layer as a kind of heat storage material. Therefore, the steam in contact with the second heat insulating layer that condenses can be reduced, and the output torque can further be increased while maintaining the work energy of the steam at the high level.

That is, “the thermal diffusivity of the first heat insulating layer is smaller than the thermal diffusivity of the second heat insulating layer” means that the followability of the temperature of the first heat insulating layer to the change in the surrounding temperature is lower than the second heat insulating layer. In other words, the first heat insulating layer has a higher temperature stability than the second heat insulating layer. In addition, since the thickness of the first heat insulating layer is larger than the thickness of the second heat insulating layer, the heat quantity stored in the first heat insulating layer is relatively large. Thus, after an engine warm-up has progressed at least to some extent, the temperature of the upper surface of the first heat insulating layer (contact surface with the second heat insulating layer) is maintained at a comparatively high value. Since the elevation of the temperature of the first heat insulating layer can push up the base temperature of the second heat insulating layer (i.e., the temperature of the second heat insulating layer when the combustion chamber becomes low in the temperature, such as during an intake stroke or an exhaust stroke), the temperature can be entirely kept high, even if the temperature of the second heat insulating layer changes according to the temperature change in the gas inside the combustion chamber. Thus, since it can reduce the possibility that the temperature of the second heat insulating layer is dropped to a temperature at which a condensation of steam occurs (a saturation temperature), the condensation of the steam in contact with the second heat insulating layer can effectively be reduced. Therefore, an amount of steam which functions as the operating gas which depresses the piston can be prevented from being substantially decreased, and the work energy of the expansion of steam can be maintained at the high value, and thereby, the output torque can further be increased.

The piston may have a cavity configured to receive the steam injected from the steam injection valve. The first heat insulating layer and the second heat insulating layer may be provided at least to the cavity.

When the cavity which receives the steam injected from the steam injection valve is provided, the flow of steam can be controlled so that at least a part of the steam stays at and around the cavity, and therefore, it can be prevented that the steam diffuses in a wide range of the combustion chamber. Therefore, the combustion stability of the mixture gas can be prevented from being degraded by the steam, and the suitable combustion stability can be secured while enjoying the torque increase effect by the steam.

Further, since at least the formed surface of the cavity is covered with the first heat insulating layer and the second heat insulating layer, the steam introduced into the cavity can be maintained at a high temperature to reduce the condensation, and therefore, the sufficient torque increase effect by the steam can be acquired.

The first heat insulating layer and the second heat insulating layer may be provided so as to cover substantially the entire crown surface of the piston including a formed surface of the cavity.

According to this configuration, the covering area by the first heat insulating layer and the second heat insulating layer is fully secured, and the improvement effects of the thermal efficiency and the output torque are increased.

The first heat insulating layer and the second heat insulating layer may be provided only to the cavity.

According to this configuration, while obtaining a necessary level of the effect of the condensation control of the steam, a utilization amount of the first heat insulating layer and the second heat insulating layer can be reduced. Moreover, the heat comparatively easily escapes from the piston crown surface other than the cavity formed surface and, therefore, there is no worry that the temperature of the combustion chamber will become excessively high, and also the possibility of abnormal combustion (e.g., knock) occurring can be reduced.

The first heat insulating layer may be a plate-like member fixed to the crown surface of the piston by a fastening member.

When the fastening member is used to fix the first heat insulating layer as described above, the joining strength of the first heat insulating layer can be secured surely even under a high-temperature condition, and reliability of the engine improves.

The second heat insulating layer may be a porous resin layer sprayed and baked onto a surface of the first heat insulating layer.

According to this configuration, the second heat insulating layer with the small thickness and the large thermal diffusivity can easily be formed.

### BRIEF DESCRIPTION OF DRAWINGS

FIG. 1 is a system chart illustrating a desirable embodiment of an engine to which a structure of a combustion chamber of the present disclosure is applied.

FIG. 2 is a plan view illustrating a crown surface of a piston which is overlapped with intake and exhaust valves.

FIG. 3 is an enlarged cross-sectional view of components around the combustion chamber, taken along a cutting plane including a cylinder axis and perpendicular to an intake-and-exhaust direction.

FIG. 4 is an enlarged cross-sectional view of an upper end part of the piston including a heat barrier layer and a heat insulating layer.

FIG. 5 is a graph illustrating changes in temperature of the heat barrier layer and the heat insulating layer in one combustion cycle.

FIG. 6 is a cross-sectional view illustrating a modification of the above embodiment.

FIG. 7 is a cross-sectional view illustrating another modification of the above embodiment.

### DETAILED DESCRIPTION OF THE DISCLOSURE

### (1) Overall Structure of Engine

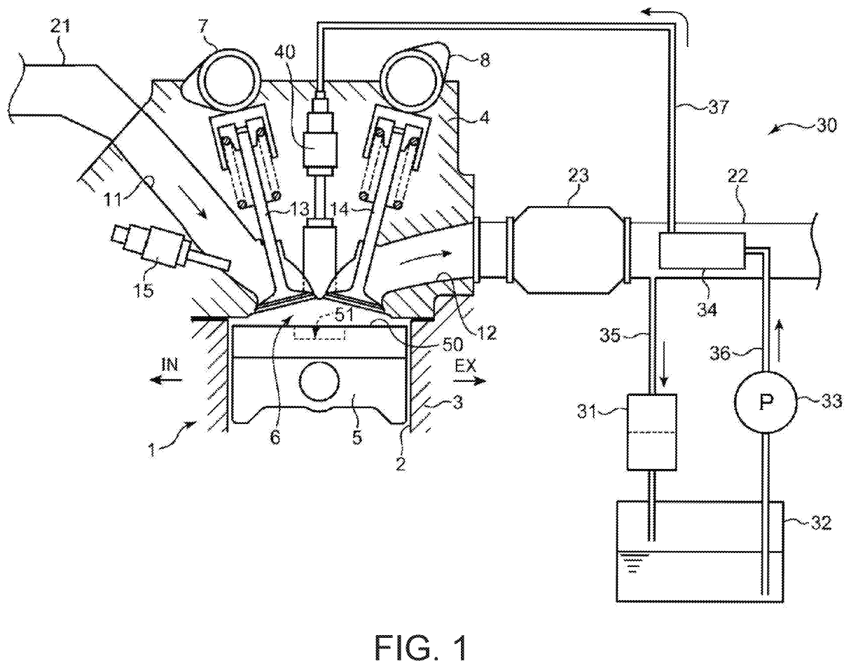

FIG. 1 is a system chart illustrating a desirable embodiment of an engine to which a structure of a combustion chamber of the present disclosure is applied. The engine illustrated in this figure is a four-cycle gasoline engine mounted on a vehicle, as a power source for the vehicle to travel, and includes an engine body 1, an intake passage 21 where intake air introduced into the engine body 1 circulates, an exhaust passage 22 where exhaust gas discharged from the engine body 1 circulates, and a water supply system 30 which supplies water taken out from the exhaust gas to the engine body 1 in a form of steam. Note that in FIG. 1, “IN” indicates an intake side (a side toward the intake passage 21 from the engine body 1) and “EX” indicates an exhaust side (a side toward the exhaust passage 22 from the engine body 1).

The engine body 1 has a cylinder block 3 where a cylinder 2 is formed therein, a cylinder head 4 attached to an upper surface of the cylinder block 3 so as to cover the cylinder 2 from above, and a piston 5 reciprocatably inserted in the cylinder 2. Note that although the engine body 1 is, actually, of a multi-cylinder type having a plurality of (e.g., four) cylinders 2 lined up in a direction perpendicular to the drawing sheet of FIG. 1, the following description fundamentally focuses on only one of the cylinders 2 for simplifying this description.

Although illustration is omitted, below the piston 5, a crankshaft which is an output shaft of the engine body 1 is provided, and the crankshaft is coupled to the piston 5 through a connecting rod.

A combustion chamber 6 is defined above the piston 5. Fuel (fuel of which the main component is gasoline) injected from an injector 15 (described later) is supplied to the combustion chamber 6. Then, the supplied fuel combusts while being mixed with air inside the combustion chamber 6, and by receiving the expansion force caused by the combustion, the piston 5 reciprocates in the up-and-down direction.

An intake port 11 and an exhaust port 12 which communicate with the combustion chamber 6 are formed in the cylinder head 4. The intake port 11 is a port where intake air introduced into the combustion chamber 6 from the intake passage 21 circulates, and the exhaust port 12 is a port where exhaust gas drawn from the combustion chamber 6 to the exhaust passage 22 circulates. An intake valve 13 which opens and closes an opening of the intake port 11 on the combustion chamber 6 side, and an exhaust valve 14 which opens and closes an opening of the exhaust port 12 on the combustion chamber 6 side are attached to the cylinder head 4.

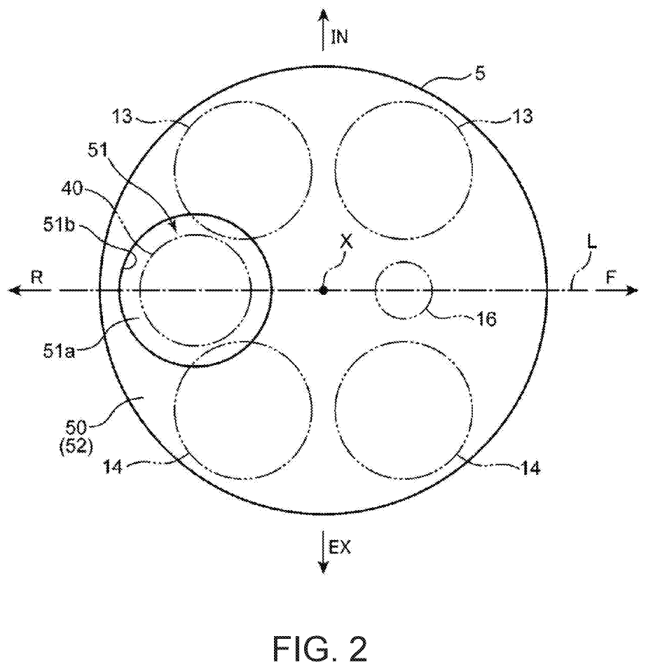

FIG. 2 is a plan view illustrating a crown surface 50 (upper surface) of the piston 5, in an overlapped fashion with the intake valve 13 and the exhaust valve 14. Note that in FIG. 2, “F” indicates a front side of the engine body 1, and “R” indicates a rear side of the engine body 1. That is, in this embodiment, a direction perpendicular to the intake-and-exhaust direction which connects the intake side (IN) and the exhaust side (EX) is referred to as the front-and-rear direction, where one side is referred to as the front side of the engine body 1 and the other side is referred to as the rear side of the engine body 1.

As illustrated in FIG. 2, a valve type of the engine of this embodiment is four-valve type which is two intake valves 13 and two exhaust valves 14. That is, regarding each cylinder 2 in this embodiment, two intake ports 11 open to an area of the combustion chamber 6 on the intake side, and two intake valves 13 corresponding to the two intake ports 11 are formed. Similarly, for every cylinder 2, two exhaust ports 12 open to an area of the combustion chamber 6 on the exhaust side, and the two exhaust valves 14 corresponding to the two exhaust ports 12 are formed.

Valve operating mechanisms 7 and 8 including cam shafts are disposed in an upper part of the cylinder head 4. The valve operating mechanism 7 interlocks with the rotation of the crankshaft to open and close the intake valve 13, and the valve operating mechanism 8 interlocks with the rotation of the crankshaft to open and close the exhaust valve 14.

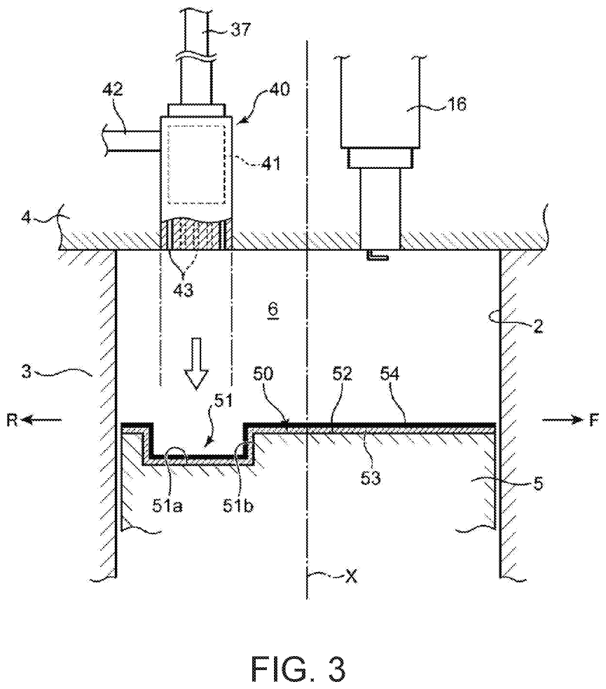

FIG. 3 is an enlarged cross-sectional view of components around the combustion chamber 6, taken along a cutting plane including a cylinder axis X which is the center axis of the cylinder 2 and parallel to the front-and-rear direction (a cutting plane perpendicular to the drawing sheet of FIG. 1). As illustrated in FIG. 3, as well as FIGS. 1 and 2, the injector 15, an ignition plug 16, and a steam injection valve 40 are provided to the cylinder head 4 for every cylinder 2. The injector 15 is an injection valve which injects fuel to the intake port 11. The ignition plug 16 is a spark plug which ignites a mixture gas inside the combustion chamber 6, i.e., the mixture gas which is formed by mixing the fuel injected from the injector 15 with air inside the combustion chamber 6. The steam injection valve 40 is an injection valve which injects steam to the combustion chamber 6, and constitutes an element of the water supply system 30. The detail of the water supply system 30 including the steam injection valve 40 will be described later.

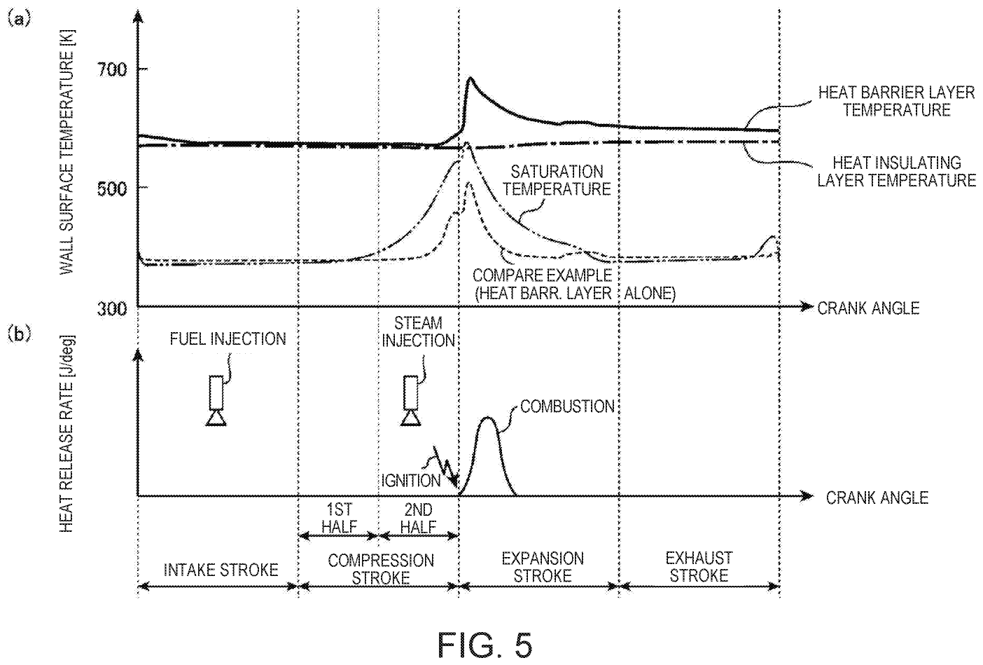

The injector 15 injects fuel during an intake stroke (mainly, in the middle period), as also illustrated in FIG. 5 described later. The fuel injected to the intake port 11 from the injector 15 during the intake stroke is introduced into the combustion chamber 6 with intake air which flows through the intake port 11, and is mixed with the air while evaporating and being atomized to become the mixture gas. The ignition plug 16 ignites the mixture gas near a compression top dead center to combust the mixture gas.

As illustrated in FIG. 3, the ignition plug 16 and the steam injection valve 40 are disposed so as to face to the crown surface 50 of the piston 5 from a ceiling surface of the combustion chamber 6. Moreover, the ignition plug 16 and the steam injection valve 40 are disposed so as to oppose to each other in the front-and-rear direction, having the cylinder axis X therebetween. That is, as illustrated in FIG. 2, when a straight line which bisects the combustion chamber 6 in the intake-and-exhaust direction in the plan view (a straight line passing through the cylinder axis X and extending in the front-and-rear direction) is a center line L, the ignition plug 16 and the steam injection valve 40 are disposed so that they are lined up in the front-and-rear direction on the center line L and oppose to each other on both sides of the cylinder axis X. The ignition plug 16 is disposed on the front side of the engine body 1 with respect to the cylinder axis X, and the steam injection valve 40 is disposed on the rear side of the engine body 1 with respect to the cylinder axis X. Note that in FIG. 2, imaginary circles representing the ignition plug 16 and the steam injection valve 40 illustrate contours of tip-end surfaces (lower end surfaces) of the ignition plug 16 and the steam injection valve 40, respectively.

A cavity 51 is formed in the crown surface 50 of the piston 5. The cavity 51 is formed in an area of the crown surface 50 which opposes to the lower end surface of the steam injection valve 40, i.e., at a slightly rearward location of a center part of the crown surface 50 in the intake-and-exhaust direction. Note that, below, the crown surface 50 of the piston 5 is suitably referred to as a “piston crown surface 50.”

The cavity 51 is a circular recess in the plan view, which is defined by a circular bottom surface 51a and a cylindrical circumferential surface 51b which rises upward from the outer circumference of the circular bottom surface 51a. In other words, the piston crown surface 50 has a flat base surface 52 which occupies areas other than the cavity 51, the bottom surface 51a of the cavity 51 which is one step lower than the base surface 52, and the circumferential surface 51b of the cavity 51 which connects the bottom surface 51a to the base surface 52.

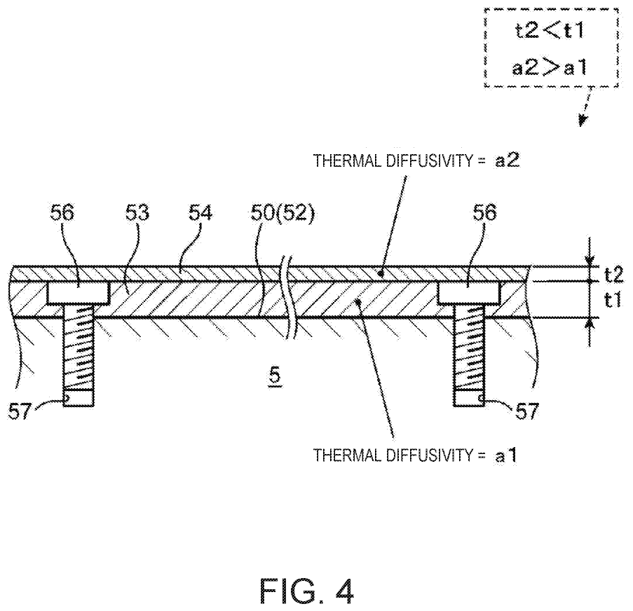

A plurality of threaded holes 57 (FIG. 4) are formed in the base surface 52 as fastened parts into which fastening members 56 (described later) fit.

The piston crown surface 50 is entirely covered with a heat insulating layer 53 and a heat barrier layer 54. That is, the heat insulating layer 53 and the heat barrier layer 54 are formed so as to cover the base surface 52 of the piston crown surface 50, and the bottom surface 51a and the circumferential surface 51b of the cavity 51. The detail of the heat insulating layer 53 and the heat barrier layer 54 will be described later.

The intake passage 21 is connected to one side surface (a side surface on the intake side) of the cylinder head 4 so as to communicate with the intake port 11. Although illustration is omitted, the intake passage 21 is provided with an air cleaner which removes foreign matters from intake air, and a throttle valve which adjusts a flow rate of the intake air which circulates inside the intake passage 21.

The exhaust passage 22 is connected to the other side surface (a side surface on the exhaust side) of the cylinder head 4 so as to communicate with the exhaust port 12. The exhaust passage 22 is provided with a catalytic converter 23 which removes hazardous components in the exhaust gas.

Here, the engine of this embodiment is a compression ignition gasoline engine in which the mixture gas formed inside the combustion chamber 6 is combustible by compression ignition combustion (hereinafter, referred to as “CI combustion”). In more detail, the combustion mode adopted to the engine of this embodiment is partial compression ignition combustion in which a portion of the mixture gas inside the combustion chamber 6 is combusted by CI combustion. The partial compression ignition combustion is a combustion mode in which a portion of the mixture gas inside the combustion chamber 6 is combusted by flame propagation combustion which is triggered by an ignition by the ignition plug 16 (hereinafter, referred to as “SI combustion”), and the remaining mixture gas inside the combustion chamber 6 carries out CI combustion when SI combustion increases the temperature and the pressure inside the combustion chamber 6. In order to realize the partial compression ignition combustion, the geometric compression ratio of the engine of this embodiment (i.e., a ratio of the volume of the combustion chamber 6 when the piston 5 is located at a top dead center to the volume of the combustion chamber 6 when the piston 5 is located at a bottom dead center) is set as a value higher than geometric compression ratios of common gasoline engines (gasoline engines in which all the mixture gas carries out SI combustion) (e.g., 16:1 or higher).

### (2) Water Supply System

As illustrated in FIG. 1, the water supply system 30 includes a condenser 31, a water tank 32, a water pump 33, a heater 34, and the steam injection valve 40 described above.

The condenser 31 is a heat exchanger which cools exhaust gas by a heat exchange with a given refrigerant (e.g., engine coolant), and is connected with the exhaust passage 22 through an extraction pipe 35. Moisture inside the exhaust gas introduced into the condenser 31 through the extraction pipe 35 from the exhaust passage 22 is cooled and condensed by the heat exchange at the condenser 31, and it is taken out as liquid water.

The water tank 32 is a container which stores the water condensed by the condenser 31.

The water pump 33 is a pump which feeds the water stored in the water tank 32 to the heater 34. The water pump 33 and the heater 34 are connected with each other through a first supply pipe 36.

The heater 34 is a heat exchanger that heats the water supplied from the water pump 33 by the heat exchange with the exhaust gas. The heater 34 and the steam injection valve 40 are connected to each other through a second supply pipe 37. The water supplied to the steam injection valve 40 from the second supply pipe 37 is liquid water at high temperature and high pressure generated by the pressurizing of the water pump 33 and the heating of the heater 34.

As illustrated in FIG. 3, the steam injection valve 40 is provided with a vaporizer 41 therein. The vaporizer 41 is a device which generates steam by evaporating the water at high temperature and high pressure supplied from the second supply pipe 37 by decompression boiling. The vaporizer 41 is connected to a heat pipe 42. Although illustration is omitted, the heat pipe 42 has, for example, a heat-receiving side end part which receives heat energy of hot exhaust gas which passes through the exhaust port 12, and a heat-release side end part which releases the heat energy moved from the heat-receiving side end part to the vaporizer 41. As a medium for this heat transfer, an operating medium which is vaporizable and condensable circulates inside the heat pipe 42. The steam supplied from the vaporizer 41 becomes comparatively hot steam by the heat energy given from the heat pipe 42. Therefore, it is avoided that liquid water mixes with steam.

The steam injection valve 40 has a plurality of nozzle holes 43 used as outlets of the steam drawn from the vaporizer 41 at a tip-end part which faces the combustion chamber 6. The plurality of nozzle holes 43 extend parallel to each other along a direction toward the cavity 51 of the piston 5 (here, downward). Therefore, as illustrated by a white arrow in FIG. 3, the steam injected into the combustion chamber 6 through the nozzle holes 43 flows substantially linearly toward the cavity 51, and is introduced into the cavity 51 along the shortest-distance route.

As also illustrated in FIG. 5 described later, the steam injection valve 40 injects steam in the second half of a compression stroke. The term “second half of a compression stroke” as used herein refers to the second half of the compression stroke when equally dividing the compression stroke into two (the first half and the second half), and is a period from 90° CA before a compression top dead center (BTDC) to 0° CA BTDC (° CA represents a crank angle). The steam injected during the second half of the compression stroke functions as operating gas inside the combustion chamber 6, and does a work to depress the piston 5.

### (3) Details of Heat Insulating Layer/Heat Barrier Layer

FIG. 4 is an enlarged cross-sectional view of an upper end part of the piston 5 including the heat insulating layer 53 and the heat barrier layer 54. As illustrated in FIGS. 3 and 4, the heat insulating layer 53 is a plate-like member having a certain thickness, and directly covers the entire piston crown surface 50 including the bottom surface 51a and the circumferential surface 51b of the cavity 51. That is, the heat insulating layer 53 closely contacts the base surface 52 of the piston crown surface 50, and the bottom surface 51a and the circumferential surface 51b of the cavity 51. The heat barrier layer 54 is a resin layer having a certain thickness, covers the entire heat insulating layer 53 from above, and closely contacts the heat insulating layer 53. In other words, the heat barrier layer 54 constitutes the outmost layer of an upper end part of the piston 5, and defines the bottom surface of the combustion chamber 6. Although the gas inside the combustion chamber 6 contacts the heat barrier layer 54, it does not contact the heat insulating layer 53 and the piston crown surface 50 (metal surface) below it.

The heat insulating layer 53 is an example of a “first heat insulating layer” in the present disclosure, and is made of a material of which thermal conductivity (unit: W/(m·K)) is smaller than that of a metallic material which constitutes the piston 5 (base material). In this embodiment, the heat insulating layer 53 is comprised of a laminated body in which glass-fiber containing sheets are laminated. In detail, the heat insulating layer 53 is a plate-like member in which glass fibers are hardened with an inorganic binder (resin) to form each sheet, and the sheets are integrally laminated. The composition of the heat insulating layer 53 includes glass fiber, inorganic resin, and silicon dioxide, and it is adjusted so that the content of glass fiber is the largest. For example, the composition may be 68 wt % glass fiber, 17 wt % silicon dioxide, and 15 wt % inorganic resin.

The heat insulating layer 53 is fixed to the piston 5 by the plurality of fastening members 56 which are fittable into the threaded holes 57 of the piston crown surface 50 (base surface 52). The plurality of fastening members 56 are disposed, for example, in the circumferential direction along a pitch circle centering on the cylinder axis X. As the fastening member 56, a bolt of a low head with a hexagon hole may be used, for example.

The heat barrier layer 54 is an example of a “second heat insulating layer” in the present disclosure, and is made of a material of which thermal conductivity (unit: W/(m·K)) is smaller than that of the metallic material which constitutes the piston 5 (base material) and different from the material of the heat insulating layer 53. In this embodiment, the heat barrier layer 54 is comprised of a porous resin layer in which hollow particles are contained in a heat-resistant silicone resin. The silicone resin may be a silicone resin made of a three-dimensional polymer with a high branching degree, which is represented by methyl silicone resin and methylphenyl silicone resin. The hollow particles may include Shirasu-balloons. The heat barrier layer 54 may be fixedly adhered to the surface of the heat insulating layer 53, for example, by a coating treatment (spraying and baking). The detail of the manufacturing method in this case will be described later.

As illustrated in FIG. 4, if the thickness of the heat insulating layer 53 is t1 and the thickness of the heat barrier layer 54 is t2, a relationship of t2<t1 can be established. That is, the thickness t2 of the heat barrier layer 54 is less than the thickness t1 of the heat insulating layer 53. As one example, the thickness t2 of the heat barrier layer 54 may desirable be 100 μm or less, and the thickness t1 of the heat insulating layer 53 may desirable be 1000 μm (1 mm) or greater. In other words, it is desirable that the thickness t2 of the heat barrier layer 54 is 1/10 or less of the thickness t1 of the heat insulating layer 53.

Here, the thickness t2 of the heat barrier layer 54 may desirably be 100 μm or less because it is to achieve both prevention of a crack which may occur when forming the heat barrier layer 54 (a crack caused by the contraction during the baking) and an appropriate heat permeability to the heat insulating layer 53. Moreover, the thickness t1 of the heat insulating layer 53 may desirably be 1000 μm or more because it is to achieve both the heat capacity required for keeping the temperature (heating) of the heat barrier layer 54, and an appropriate strength against a compressive stress occurring when fastening the fastening member 56. On the contrary, as long as these requirements are satisfied, the thickness t2 of the heat barrier layer 54 may be larger than 100 and the thickness t1 of the heat insulating layer 53 may be smaller than 1000 μm.

If thermal diffusivity of the heat insulating layer 53 is a1 and thermal diffusivity of the heat barrier layer 54 is a2, a relationship of a2>a1 can be established. That is, the thermal diffusivity a2 of the heat barrier layer 54 is larger than the thermal diffusivity a1 of the heat insulating layer 53. The thermal diffusivity is a property value representing a rate of change with time in the temperature distribution in the material (unit: m²/s), and it is also referred to as a thermodiffusion coefficient, a thermal diffusion factor, or a thermal diffusion coefficient. When this value is larger, it means that the rate of change with time in the temperature is faster. Note that when the thermal conductivity is k [W/(m·K)], the density is ρ [g/m³], and the specific heat is C [J/(g·K)], the thermal diffusivity can be defined as k/(ρ·C). As one example, the thermal diffusivity a2 of the heat barrier layer 54 can be 0.15 m²/s, and the thermal diffusivity a1 of the heat insulating layer 53 can be 0.12 m²/s.

### (4) Method of Forming Heat Barrier Layer/Heat Insulating Layer

The heat insulating layer 53 and the heat barrier layer 54 can be formed by the following procedures.

First, the heat insulating layer 53 having a shape which conforms to the shape of the piston crown surface 50 including the cavity 51 is prepared and fixed to the piston crown surface 50 by using the fastening members 56. That is, the heat insulating layer 53 having a flat part which conforms to the shape of the base surface 52 of the piston crown surface 50 and a concave part which conforms to the shapes of the bottom surface 51a and the circumferential surface 51b of the cavity 51 is prepared, and the heat insulating layer 53 is fixedly fastened to the piston crown surface 50 so that every surface (52, 51a, and 51b) of the piston crown surface 50 is covered with the flat part and the concave part.

Next, a raw material (the silicone resin and the hollow particles which are diluted with diluent solutions, such as toluene) of the heat barrier layer 54 is sprayed onto the surface of the heat insulating layer 53 fixed to the piston crown surface 50 as described above, by using a spray device. This forms a resin coating which continuously covers the heat insulating layer 53 and the fastening members 56.

Next, the resin coating is heated in a furnace to form the heat barrier layer 54. That is, by feeding the resin coating sprayed onto the surface of the heat insulating layer 53 into the furnace together with the heat insulating layer 53 and the piston 5 and heating them to a given temperature, the resin coating is baked to form the heat barrier layer (volatilizing the diluent solution) 54.

Through the processes described above, the entire piston crown surface 50 can be covered with the two layers of the heat insulating layer 53 and the heat barrier layer 54 in the order from below (from the piston crown surface 50 side).

### (5) Operation and Effects

As described above, in the engine of this embodiment, the piston crown surface 50 is covered with the heat insulating layer 53, and the surface of this heat insulating layer 53 is further covered with the heat barrier layer 54 which is relatively large in the thermal diffusivity and small in the thickness. According to such a structure, there is an advantage that the cooling loss can be reduced to effectively improve the thermal efficiency of the engine.

That is, in this embodiment, since the piston crown surface 50 is dually covered with the heat insulating layer 53 and the heat barrier layer 54, the combustion heat generated in the combustion chamber 6 that is emitted outside via the piston crown surface 50 can be reduced, and therefore, the cooling loss can be reduced. Particularly, since the thermal diffusivity a2 of the heat barrier layer 54 which faces the combustion chamber 6 (directly contacts combustion gas) is relatively large, the temperature of the heat barrier layer 54 can be raised when the temperature inside the combustion chamber 6 elevates according to the combustion of the mixture gas so that the temperature rise quickly follows the temperature rise inside the combustion chamber 6. Therefore, a temperature difference between the heat barrier layer 54 and the combustion chamber 6 can be made small as much as possible, and thereby, the cooling loss which originates in this temperature difference can fully be reduced. Moreover, since the thickness t1 of the heat insulating layer 53 located between the heat barrier layer 54 and the piston crown surface 50 is relatively large, the heat transfer from the heat barrier layer 54 to the piston crown surface 50 can fully be reduced by the heat insulating layer 53, and therefore, the cooling loss can also be reduced. As described above, according to this embodiment, since the cooling loss is fully reduced by the combination of the heat insulating layer 53 and the heat barrier layer 54, the thermal efficiency of the engine can be significantly improved.

Moreover, in this embodiment, since the steam injection valve 40 which injects steam toward the piston crown surface 50 from the ceiling surface of the combustion chamber 6 is attached to the cylinder head 4, the injected steam can be used as the operating gas, and therefore, the output torque of the engine can be increased. That is, the steam injected into the combustion chamber 6 from the steam injection valve 40 expands inside the combustion chamber 6, and therefore, it functions as the operating gas which depresses the piston 5. Therefore, the work (energy) which depresses the piston 5 increases to increase the output torque. In addition, since not liquid water but steam is injected, the amount by which the energy is increased can be prevented from being deducted by energy consumption by latent heat of vaporization of water, and the output torque can be effectively increased.

Particularly, in this embodiment, since the heat insulating layer 53 with the relatively small thermal diffusivity and large thickness is disposed between the heat barrier layer 54 and the piston crown surface 50, the temperature of the heat barrier layer 54 which directly contacts the gas inside the combustion chamber 6 including the steam can be raised averagely by using the heat insulating layer 53 as a kind of heat storage material. Therefore, the steam in contact with the heat barrier layer 54 that condenses (dropwise condensation) can be reduced, and the output torque can further be increased while maintaining the work energy of the steam at the high level.

That is, “the thermal diffusivity a1 of the heat insulating layer 53 is less than the thermal diffusivity a2 of the heat barrier layer 54” means that the followability of the temperature of the heat insulating layer 53 to the change in the surrounding temperature is lower than the heat barrier layer 54. In other words, the heat insulating layer 53 has a higher temperature stability than the heat barrier layer 54. In addition, since the thickness t1 of the heat insulating layer 53 is larger than the thickness t2 of the heat barrier layer 54, the heat quantity stored in the heat insulating layer 53 relatively increases. Thus, after an engine warm-up has progressed at least to some extent, the temperature of the upper surface of the heat insulating layer 53 (contact surface with the heat barrier layer 54) is maintained at a comparatively high value. Since the elevation of the temperature of the heat insulating layer 53 can push up the base temperature of the heat barrier layer 54 (i.e., the temperature of the heat barrier layer 54 when the combustion chamber becomes low in the temperature, such as during an intake stroke or an exhaust stroke), the temperature can be entirely kept high, even if the temperature of the heat barrier layer 54 changes according to the temperature change in the gas inside the combustion chamber 6. Thus, since it can reduce the possibility that the temperature of the heat barrier layer 54 is dropped to a temperature at which a condensation of steam occurs (a saturation temperature), the condensation of the steam in contact with the heat barrier layer 54 can effectively be reduced. Therefore, an amount of steam which functions as the operating gas which depresses the piston 5 can be prevented from being substantially decreased, and the work energy of the expansion of steam can be maintained at the high value, and thereby, the output torque can further be increased.

Moreover, in this embodiment, since the cavity 51 which receives the steam injected from the steam injection valve 40 is formed in the piston crown surface 50, the flow of steam can be controlled so that at least a portion of the steam stays at and around the cavity 51, and therefore, the steam diffusing in a wide range of the combustion chamber 6 can be prevented. Therefore, the combustion stability of the mixture gas can be prevented from being degraded by the steam, and the suitable combustion stability can be secured while enjoying the torque increase effect by the steam.

Further, in this embodiment, since the entire piston crown surface 50 including the formed surface of the cavity 51 (the bottom surface 51a and the circumferential surface 51b) is covered with the heat insulating layer 53 and the heat barrier layer 54, the steam introduced into the cavity 51 can be maintained at a high temperature to reduce the condensation, and therefore, the sufficient torque increase effect by the steam can be acquired.

FIG. 5 is a graph illustrating a result of a confirmation experiment which is conducted by the present inventors in order to confirm the effects described above. Here, the upper chart (a) illustrates the temperature change of the combustion chamber 6 in one combustion cycle, and the lower chart (b) illustrates a flow of a control in one combustion cycle and a combustion waveform (a rate of heat release).

As illustrated in the chart (b) of FIG. 5, in this embodiment, a fuel injection by the injector 15, a steam injection by the steam injection valve 40, and a jump-spark ignition by the ignition plug 16 are performed in this order in one combustion cycle. In detail, the fuel injection is performed during an intake stroke, the steam injection is performed in the second half of a compression stroke, and the jump-spark ignition is performed near a compression top dead center (a top dead center between the compression stroke and an expansion stroke). Therefore, combustion of the mixture gas is started immediately after the jump-spark ignition, and combustion heat occurs during a period from near the compression top dead center to the middle of the expansion stroke.

According to the combustion of the mixture gas as described above, the temperature of the combustion chamber 6 changes like the chart (a). Note that in this chart, a waveform of a “heat barrier layer temperature” represents a temperature of the upper surface of the heat barrier layer 54, a waveform of a “heat insulating layer temperature” represents a temperature of the upper surface of the heat insulating layer 53, and a waveform of a “saturation temperature” represents a temperature at which the condensation of steam occurs. In addition, as a comparative example, a temperature of an upper surface of the heat barrier layer in the piston where the heat insulating layer is omitted and only the heat barrier layer is provided is illustrated.

As illustrated in the chart (a), the temperature of the upper surface of the heat insulating layer 53 does not change greatly in one combustion cycle (one cycle of intake, compression, expansion, and exhaust strokes), and is maintained at a comparatively high temperature (near 600K). On the other hand, although the temperature of the upper surface of the heat barrier layer 54 is maintained substantially at the same temperature as the upper surface of the heat insulating layer 53 until slightly before the compression top dead center, it then goes up rapidly and becomes about 700K, and after that, it falls gradually during a period from the expansion stroke to the exhaust stroke. Thus, the temperature of the upper surface of the heat barrier layer 54 changes based on the temperature of the upper surface of the heat insulating layer 53, and it notably increases before and after the compression top dead center where the temperature of the gas inside the combustion chamber 6 increases. Therefore, the temperature of the upper surface of the heat barrier layer 54 is always maintained at a temperature higher than the saturation temperature (the temperature at which steam condenses). This means that the condensation of steam in contact with the upper surface of the heat barrier layer 54 can be avoided. Note that the increase in the saturation temperature before and after the compression top dead center is caused by an increase in the pressure of the combustion chamber 6.

On the other hand, when the piston crown surface 50 is covered only with the one layer of the heat barrier layer (a layer equivalent to the heat barrier layer 54) like the comparative example, although the temperature of the upper surface of the heat barrier layer rises during a period around the compression top dead center where the combustion chamber 6 becomes hot (mainly, a period from the second half of the compression stroke to the first half of the expansion stroke), the temperature is significantly lower than the temperature (“heat barrier layer temperature”) when the structure of the embodiment is adopted. This is because the base temperature which is the temperature of the heat barrier layer when the temperature of the gas inside the combustion chamber is low, such as during the intake stroke and the exhaust stroke, is low. That is, since the heat insulating layer does not exist underneath the heat barrier layer in the comparative example, the heat easily escapes from the heat barrier layer to the metal part of the piston crown surface. Thus, the temperature of the heat barrier layer drops so as to exactly follow the temperature of the gas inside the combustion chamber which drops during a period excluding around the compression top dead center (particularly, the intake stroke and the exhaust stroke), and this lowers the base temperature. On the other hand, the temperature of the heat barrier layer goes up so as to follow the temperature of the gas inside the combustion chamber around the compression top dead center, but, since the response in this case is limited, if the base temperature is low as described above, an absolute value of the temperature around the compression top dead center inevitably drops. Therefore, in the comparative example, the temperature of the heat barrier layer around the compression top dead center becomes significantly lower than this embodiment, and as a result, it can only rise to a low temperature which is lower than the saturation temperature. This leads to the condensation of steam in contact with the heat barrier layer. In addition, since the temperature difference between the combustion gas and the heat barrier layer in contact with the combustion gas increases, this also leads to an increase in the cooling loss. Thus, in the comparative example, since the steam cannot fully be utilized as the operating gas and the cooling loss cannot fully be reduced, the improvement effects of the thermal efficiency and the output torque are not high enough as compared with this embodiment.

In other words, since in this embodiment the temperature difference between the combustion gas and the heat barrier layer 54 is reduced and the generation of the condensed water is reduced by the effect of further providing the heat insulating layer 53 underneath the heat barrier layer 54, the improvement effects of the thermal efficiency and the output torque are fully enjoyed.

### (6) Modifications

In the above embodiment, as the method of forming the heat insulating layer 53 and the heat barrier layer 54 on the piston crown surface 50, the heat insulating layer 53 is fixedly fastened to the piston crown surface 50, the heat barrier layer 54 is then coated (sprayed and baked) on the surface of the heat insulating layer 53; however, the present disclosure is not limited to this configuration. For example, the heat barrier layer 54 may be coated on the surface of the heat insulating layer 53 in advance, and the heat insulating layer 53 and the heat barrier layer 54 which are united by the coating are fixed together to the piston crown surface 50 by using the fastening member.

In the above embodiment, although the fastening member 56 is used for fixing the heat insulating layer 53 to the piston crown surface 50, the present disclosure is not limited to this configuration. For example, the heat insulating layer 53 may be fixed to the piston crown surface 50 by using a heat-resistant adhesive. Note that since the fastening member is easier to secure the joining strength even under a high-temperature condition, it is more desirable to use the fastening member in terms of reliability.

Although the heat barrier layer 54 is fixedly adhered to the heat insulating layer 53 by the coating treatment (spraying and baking) in the above embodiment, the heat barrier layer 54 is also possible to be formed by other methods. For example, after preparing a thin heat barrier layer in advance, the heat barrier layer may be fixed onto the surface of the heat insulating layer by using a heat-resistant adhesive.

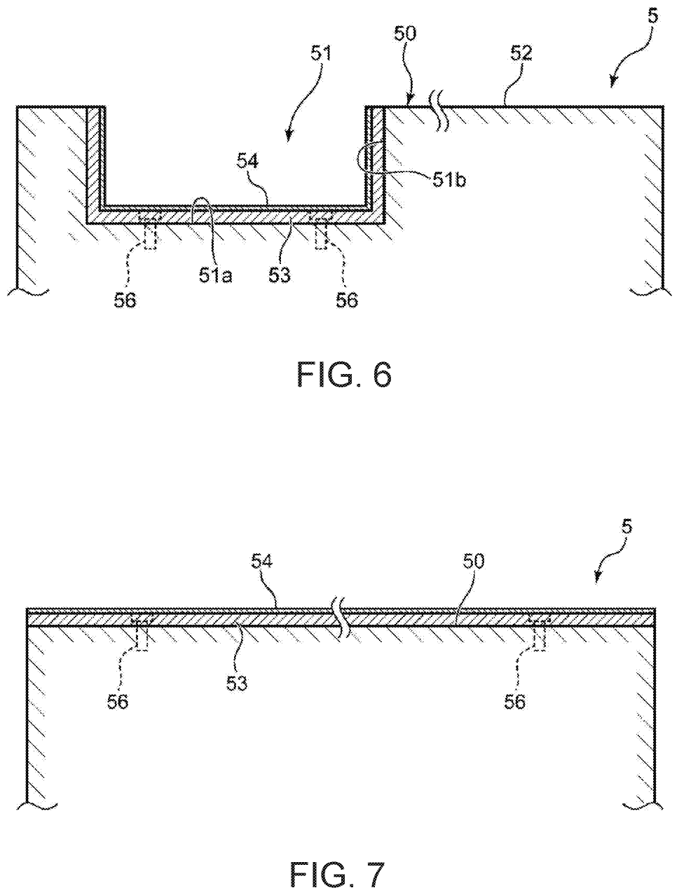

Although the heat insulating layer 53 and the heat barrier layer 54 are provided to the entire piston crown surface 50 including the formed surface of the cavity 51 (the bottom surface 51a and the circumferential surface 51b) in the above embodiment, the heat insulating layer 53 and the heat barrier layer 54 may be provided at least to the cavity 51, from the viewpoint of obtaining a necessary level of the effect of the condensation control of the steam injected from the steam injection valve 40. FIG. 6 is a cross-sectional view illustrating this example. In this example of FIG. 6, only the formed surface of the cavity 51 is covered with the heat insulating layer 53 and the heat barrier layer 54, and the base surface 52 which excludes the formed surface of the cavity 51 from the piston crown surface 50 is covered with neither the heat insulating layer 53 nor the heat barrier layer 54. Such a structure can be acquired by attaching the heat insulating layer 53 having a channel shape (a bowl shape) in cross section covering the bottom surface 51a and the circumferential surface 51b of the cavity 51 to the inside of the cavity 51 by the fastening member 56 and coating the surface of the attached heat insulating layer 53 with the heat barrier layer 54.

Although the cavity 51 is provided in order to reduce the diffusion of the injected steam and to secure the combustion stability in the above embodiment, the necessary level of the combustion stability may be securable without providing the cavity 51, depending on the engine. Therefore, the cavity 51 is not essential and it may be omitted. In this case, as illustrated in FIG. 7, since the steam contacts a large area of the piston crown surface 50, it is desirable to cover the entire piston crown surface 50 with the heat insulating layer 53 and the heat barrier layer 54.

Although the steam injection valve 40 which injects the steam to the combustion chamber 6 is attached to the cylinder head 4 in the above embodiment, the steam injection valve 40 is not essential and it may be omitted.

Although the port injection type injector 15 which injects fuel to the intake port 11 is attached to the cylinder head 4 in the above embodiment, the injector may be of a direct injection type which directly injects fuel into the combustion chamber, as long as it is able to supply fuel to the combustion chamber.

Although the piston crown surface 50 which defines the bottom surface (lower wall surface) of the combustion chamber 6 is covered with the heat insulating layer 53 (first heat insulating layer) and the heat barrier layer 54 (second heat insulating layer) in the above embodiment, the first heat insulating layer and the second heat insulating layer of the present disclosure may be also applicable to wall surfaces of the combustion chamber other than the piston crown surface. For example, the first heat insulating layer and the second heat insulating layer may also be applicable to the ceiling surface of the combustion chamber 6, lower surfaces of umbrella parts of the intake and exhaust valves, and a circumferential wall of the cylinder 2 (an inner circumferential surface of the cylinder block 3).

Although the combustion chamber structure of the present disclosure is applied to the compression ignition type gasoline engine in the above embodiment, it is also applicable to conventional jump spark ignition gasoline engines and diesel engines.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### DESCRIPTION OF REFERENCE CHARACTERS

2: Cylinder
5: Piston
6: Combustion Chamber
40: Steam Injection Valve
50: Crown Surface (of Piston)
51: Cavity
51a: Bottom Surface (Formed Surface of Cavity)
51b: Circumferential Surface (Formed Surface of Cavity)
53: Heat Insulating Layer (First Heat Insulating Layer)
54: Heat Barrier Layer (Second Heat Insulating Layer)
56: Fastening Member
a1: Thermal Diffusivity (of Heat Insulating Layer)
a2: Thermal Diffusivity (of Heat Barrier Layer)
t1: Thickness (of Heat Insulating Layer)
t2: Thickness (of Heat Barrier Layer)

What is claimed is:

1. A structure of a combustion chamber applied to an engine provided with a piston configured to reciprocate inside a cylinder to define the combustion chamber and a fuel supply system configured to supply fuel to the combustion chamber where a mixture gas of the fuel and air combusts, the structure comprising:
a first heat insulating layer covering at least a part of a combustion chamber wall surface defining the combustion chamber and made of a material with a lower thermal conductivity than the combustion chamber wall surface; and
a second heat insulating layer covering the first heat insulating layer and facing toward the combustion chamber, a thermal diffusivity of the second heat insulating layer being larger than the thermal diffusivity of the first heat insulating layer,
wherein the second heat insulating layer has a thickness less than the first heat insulating layer.

2. The structure of claim 1,
wherein the engine is provided with a steam injection valve configured to inject steam toward a crown surface of the piston, and
wherein the first heat insulating layer and the second heat insulating layer are provided to the crown surface of the piston.

3. The structure of claim 2,
wherein the piston has a cavity configured to receive the steam injected from the steam injection valve, and
wherein the first heat insulating layer and the second heat insulating layer are provided at least to the cavity.

4. The structure of claim 3, wherein the first heat insulating layer and the second heat insulating layer are provided so as to cover substantially the entire crown surface of the piston including a formed surface of the cavity.

5. The structure of claim 3, wherein the first heat insulating layer and the second heat insulating layer are provided only to the cavity.

6. The structure of claim 5, wherein the first heat insulating layer is a plate-like member fixed to the crown surface of the piston by a fastening member.

7. The structure of claim 6, wherein the second heat insulating layer is a porous resin layer sprayed and baked onto a surface of the first heat insulating layer.

8. The structure of claim 1, wherein the second heat insulating layer is a porous resin layer sprayed and baked onto a surface of the first heat insulating layer.

9. The structure of claim 2, wherein the first heat insulating layer is a plate-like member fixed to the crown surface of the piston by a fastening member.

10. The structure of claim 2, wherein the second heat insulating layer is a porous resin layer sprayed and baked onto a surface of the first heat insulating layer.

11. The structure of claim 3, wherein the first heat insulating layer is a plate-like member fixed to the crown surface of the piston by a fastening member.

12. The structure of claim 3, wherein the second heat insulating layer is a porous resin layer sprayed and baked onto a surface of the first heat insulating layer.

13. The structure of claim 4, wherein the first heat insulating layer is a plate-like member fixed to the crown surface of the piston by a fastening member.

14. The structure of claim 4, wherein the second heat insulating layer is a porous resin layer sprayed and baked onto a surface of the first heat insulating layer.

15. The structure of claim 5, wherein the second heat insulating layer is a porous resin layer sprayed and baked onto a surface of the first heat insulating layer.

16. The structure of claim 9, wherein the second heat insulating layer is a porous resin layer sprayed and baked onto a surface of the first heat insulating layer.

17. The structure of claim 11, wherein the second heat insulating layer is a porous resin layer sprayed and baked onto a surface of the first heat insulating layer.

18. The structure of claim 13, wherein the second heat insulating layer is a porous resin layer sprayed and baked onto a surface of the first heat insulating layer.
